(19) United States
(12) Patent Application Publication
(10) Pub. No.: US 2025/0043164 A1
(43) Pub. Date: Feb. 6, 2025

(54) SINGLE-COMPONENT EPOXY ADHESIVE COMPOSITION AND PREPARATION METHOD THEREOF

(71) Applicant: 3M INNOVATIVE PROPERTIES COMPANY, St. Paul, MN (US)

(72) Inventors: Lingjie Tong, Shanghai (CN); Jiaxing Sun, Shanghai (CN)

(21) Appl. No.: 18/714,726

(22) PCT Filed: Dec. 1, 2022
(86) PCT No.: PCT/IB2022/061622

§ 371 Date: May 30, 2024

(30) Foreign Application Priority Data
Dec. 2, 2021 (CN) 202111471804.6

(51) Int. Cl. C09J 163/00; C08G 59/24; C08G 59/66; C08G 59/68; C08K 5/54; C08K 5/55; C09J 11/06

(52) U.S. Cl. CPC C09J 163/00; C08G 59/24; C08G 59/66; C08G 59/686; C08K 5/54; C08K 5/55; C09J 11/06

(57) ABSTRACT

The present invention provides a single-component epoxy adhesive composition and a preparation method thereof. The single-component epoxy adhesive composition comprises, based on the total weight thereof as 100 wt %: 42-67 wt % of an epoxy resin without a benzene ring structure; 32-57 wt % of a polymercaptan; and 0.1-12 wt % of an initiator. The single-component epoxy adhesive composition according to a technical solution of the invention has high light transmittance after curing, long time available for construction, good adhesion, and in particular good weather resistance (yellowing resistance), and is suitable for electronic industrial assembly, and especially for the assembly and sealing of electronic display devices.

### TECHNICAL FIELD

The present invention relates to the technical field of epoxy adhesives used in the electronic industry, and more specifically, to a single-component epoxy adhesive composition and a preparation method thereof.

### BACKGROUND ART

Epoxy resin adhesives have good chemical stability, corrosion resistance, and adhesion, and thus they are widely used in the field of electronic packaging. However, the aging resistance of ordinary epoxy resins is poor, and yellowing will occur in the process of use, and especially in the processing of ultraviolet radiation. This is not suitable for applications with aging resistance requirements. In addition, in a common oxidation resistant epoxy resin in the market, due to the addition of a filler for resisting yellowing, the epoxy resin loses its transparency despite its oxidation resistance, leading to the inability to meet the requirements in applications requiring both oxidation resistance and transparency. In particular, the LED field, especially the LED packaging field, needs the effective export from LED light sources, which requires that the epoxy resin adhesive used for the assembly and sealing of LED devices has good light transmittance and yellowing resistance while providing sufficient time available for construction and high adhesion.

### SUMMARY

Therefore, it is hoped that such an epoxy adhesive for electronic devices in the field may be developed, which has high light transmittance after curing, good time available for construction, adhesion, and weather resistance.

Starting from the technical problems described above, the present invention aims to provide a single-component epoxy adhesive composition and a preparation method thereof. The single-component epoxy adhesive composition has high light transmittance after curing, long time available for construction, good adhesion, and in particular good weather resistance (yellowing resistance), and is suitable for electronic industrial assembly, and especially for the assembly and sealing of electronic display devices.

The inventors of the present invention have conducted intensive and detailed research to obtain the present invention.

According to one aspect of the invention, there is provided a single-component epoxy adhesive composition comprising, based on the total weight thereof as 100 weight percent (wt %):
42-67 wt % of an epoxy resin without a benzene ring structure;
32-57 wt % of a polymercaptan; and
0.1-12 wt % of an initiator.

According to another aspect of the invention, there is provided a method for preparing the single-component epoxy adhesive composition, the method comprising uniformly mixing each component of the single-component epoxy adhesive composition as described above.

Compared with the existing techniques in the art, the present invention has the following advantages: The single-component epoxy adhesive composition according to a technical solution of the invention has high light transmittance after curing (light transmittance ≥95%), long time available for construction (more than 24 h), good adhesion (shear strength ≥5 MPa), and in particular good weather resistance (the epoxy adhesive is not yellowed and the light transmittance is ≥90% after irradiation with 405 nm-wavelength UV LED at an illuminance of 5 W/cm² for 200 h), and is suitable for electronic industrial assembly, and especially for the assembly and sealing of electronic display devices.

### DETAILED DESCRIPTION

It should be appreciated that various other embodiments could be devised and modified by a person skilled in the art in light of the teachings of this description without departing from the scope or spirit of the present disclosure. Therefore, the following particular embodiments are not restrictive in meaning.

Unless otherwise indicated, all numbers used in this description and claims for the dimensions, quantities, and physicochemical properties of features should be construed to be modified by the term “approximately” in all instances. Accordingly, unless indicated to the contrary, the above numerical parameters listed in the description and attached claims are all approximations, which can be properly altered by a person skilled in the art using desired properties sought to be obtained from the teachings disclosed herein. The use of numerical ranges indicated by endpoints includes all numbers within that range and any range within that range, for example, 1 to 5 includes 1, 1.1, 1.3, 1.5, 2, 2.75, 3, 3.80, 4, and 5, etc.

Through in-depth research by the present inventors, it is unexpectedly found that, a combination of an epoxy resin without a benzene ring structure, polymercaptan and an initiator in specific contents can provide a single-component epoxy adhesive composition (herein also referred to as an epoxy adhesive) with high light transmittance after curing, long time available for construction, good adhesion, and in particular good weather resistance (yellowing resistance).

Particularly, according to one aspect of the invention, there is provided a single-component epoxy adhesive composition comprising, based on the total weight thereof as 100 wt %:
42-67 wt % of an epoxy resin without a benzene ring structure;
32-57 wt % of a polymercaptan; and
0.1-12 wt % of an initiator.

According to a technical solution of the invention, an epoxy resin without a benzene ring structure is used as a basic material for the single-component epoxy adhesive composition. As used herein, the term “epoxy resin without a benzene ring structure” refers to an organic compound containing two or more epoxy groups and containing no benzene ring structure in its molecule, which may be a high molecular weight compound. The present inventors find that the presence of the benzene ring structure in the epoxy resin will greatly reduce the aging resistance, and especially the ultraviolet aging resistance, of the obtained epoxy adhesive. Preferably, the epoxy resin without a benzene ring structure is an epoxy resin with a cyclohexane structure and without a benzene ring structure. Compared with the epoxy resin without a cyclohexane structure and a benzene ring structure, the presence of a cyclohexane structure in the epoxy resin can greatly improve the adhesion of the obtained epoxy adhesive. Preferably, the epoxy resin without a benzene ring structure is a diglycidyl ether epoxy resin with a cyclohexane structure and without a benzene ring structure. Preferably, the epoxy resin without a benzene ring structure has an epoxy functionality of 2 or 3. Preferably, the epoxy resin without a benzene ring structure is a liquid epoxy resin. Preferably, the epoxy resin without a benzene ring structure has a number average molecular weight ranging from 200 to 500 grams per mole. For non-polymeric materials, the epoxy resin without a benzene ring structure can have a molecular weight ranging from 200 to 500 grams per mole. Preferably, the epoxy resin without a benzene ring structure that can be used here is selected from one or more of hydrogenated bisphenol A diglycidyl ether, 1,4-cyclohexanedimethanol diglycidyl ether, and/or trimethylolpropane triglycidyl ether with structural formulas as follows.

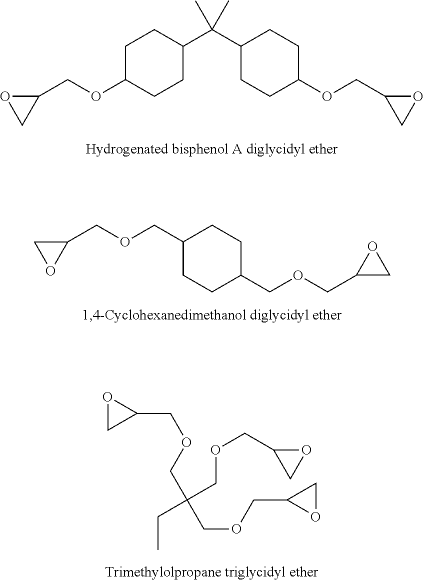 [SMILES: CC(C)(C1CCC(OCC2CO2)CC1)C1CCC(OCC2CO2)CC1 ; C1CC(COCC2CO2)CCC1COCC1CO1 ; CCC(COCC1CO1)(COCC1CO1)COCC1CO1]

Commercially available examples of the epoxy resin without a benzene ring structure that can be used here include: YX8000D (hydrogenated bisphenol A diglycidyl ether) produced by Mitsubishi Chemical Corporation: Heloxy 107 (1,4-cyclohexanedimethanol diglycidyl ether) produced by Hansen Chemical Corporation; and GE-30 (trimethylolpropane triglycidyl ether) produced by CVC Thermosetting Special Materials Corporation.

The content of the epoxy resin without a benzene ring structure in the single-component epoxy adhesive composition has an important influence on the performance of the epoxy adhesive obtained. Based on the total weight of the single-component epoxy adhesive composition as 100 wt %, the single-component epoxy adhesive composition comprises 42-67 wt % of the epoxy resin without a benzene ring structure. When the content of the epoxy resin without a benzene ring structure is less than 42 wt %, the adhesion of the resulting epoxy adhesive after curing is poor, which does not meet the requirements for epoxy adhesive products for electronic industry assembly. When the content of the epoxy resin without a benzene ring structure is more than 67 wt %, the adhesion of the resulting epoxy adhesive after curing is poor, which does not meet the requirements for epoxy adhesives for electronic industry assembly. In addition, the UV resistance of the epoxy adhesive is reduced to a certain extent. Preferably, the single-component epoxy adhesive composition comprises, based on the total weight thereof as 100 wt %, 45-65 wt % of the epoxy resin without a benzene ring structure, or 50-65 wt % of the epoxy resin without a benzene ring structure. By controlling the content of the epoxy resin without a benzene ring structure to a range of 45-65 wt %, the time available for construction of the obtained epoxy adhesive can be increased to 2 days or more. As used herein, the term “time available for construction” refers to the time during which the prepared epoxy adhesive is placed at room temperature (23° C.) until its viscosity increases by 50%.

The single-component epoxy adhesive composition according to the invention further comprises a polymercaptan as an essential component for crosslinking with the epoxy resin without a benzene ring structure. As used herein, the term “polymercaptan” refers to an organic compound with 3 or more mercapto groups in its molecule. Preferably, the polymercaptan is selected from one or more of trimethylolpropane tri (3-mercaptopropionate) (TMPMP), pentaerythritol tetra-3-mercaptopropionate (PETMP), and/or tri[2-(3-mercaptopropionyloxy)ethyl] isocyanurate (TEMPIC) with structural formulas as follows.

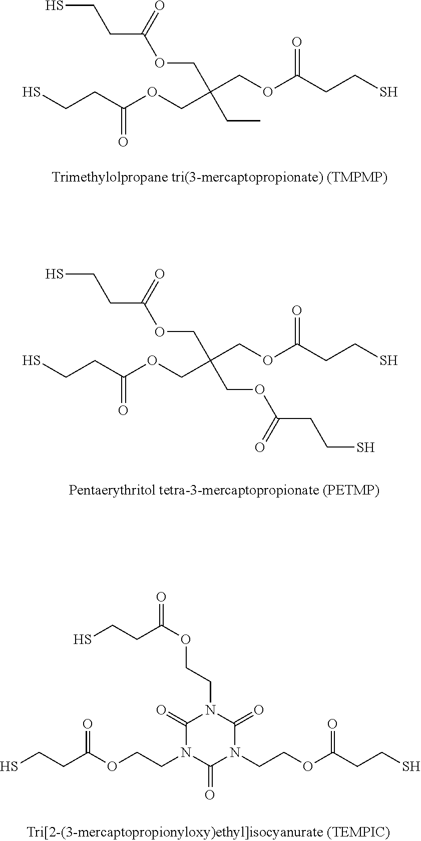 [SMILES: CCC(COC(=O)CCS)(COC(=O)CCS)COC(=O)CCS ; O=C(CCS)OCC(COC(=O)CCS)(COC(=O)CCS)COC(=O)CCS ; O=C(CCS)OCCn1c(=O)n(CCOC(=O)CCS)c(=O)n(CCOC(=O)CCS)c1=O]

Commercially available examples of polymercaptan without a benzene ring structure that can be used in the present invention include: TMPMP (trimethylolpropane tri (3-mercaptopropionate)) produced by Bruno Bock Company; PETMP (pentaerythritol tetra-3-mercaptopropionate) produced by Bruno Bock Company; and TEMPIC (tri[2-(3-mercaptopropionyloxy)ethyl]isocyanurate) produced by Bruno Bock Company.

The content of polymercaptan in the single-component epoxy adhesive composition has an important influence on the performance of the obtained epoxy adhesive. Based on the total weight of the single-component epoxy adhesive composition as 100 wt %, the single-component epoxy adhesive composition comprises 32-57 wt % of polymercaptan. When the content of polymercaptan is less than 32 wt %, the adhesion of the resulting epoxy adhesive after curing is poor, which does not meet the requirements for epoxy adhesive products for electronic industry assembly. When the content of polymercaptan is more than 57 wt %, the adhesion of the resulting epoxy adhesive after curing is poor, which does not meet the requirements for epoxy adhesives for electronic industry assembly. In addition, the UV resistance of the epoxy adhesive is reduced to a certain extent.

The single-component epoxy adhesive composition according to the invention also comprises an initiator for initiating a crosslinking reaction between the epoxy resin without a benzene ring structure and polymercaptan. Initiators that can be used in the present invention may be specifically selected from one or more of latent amine initiators and/or imidazole initiators commonly used in the art. Preferably, the imidazole initiator may be one or more of 2-ethyl-4-methylimidazole and/or 2-heptadecyl imidazole. Based on the total weight of the single-component epoxy adhesive composition as 100 wt %, the single-component epoxy adhesive composition comprises 0.1-12 wt % of the initiator. When the initiator content of exceeds 12 wt %, the light transmittance of the resulting epoxy adhesive after curing degrades, and its UV resistance decreases significantly.

In order to improve the room temperature stability of the epoxy adhesive, the single-component epoxy adhesive composition according to the invention may optionally further comprise a system stabilizer. Preferably, the system stabilizer is selected from one or more of dineopentyl glycol metaborate and/or 1-benzyl-5-phenylbarbituric acid. Preferably, based on the total weight of the single-component epoxy adhesive composition as 100 wt %, the single-component epoxy adhesive composition comprises a system stabilizer of less than or equal to 2.8 wt %.

In addition, in order to enhance the adhesion strength when the epoxy adhesive is applied to the bonding interface of the electronic component, the single-component epoxy adhesive composition according to the invention optionally further comprises a silane coupling agent. Preferably, based on the total weight of the single-component epoxy adhesive composition as 100 wt %, the single-component epoxy adhesive composition comprises a silane coupling agent of less than or equal to 0.6 wt %.

In addition, as is known to a person skilled in the art, according to the requirements of practical application, the single-component epoxy adhesive composition of the invention may also contain other ingredients or additives well known in the art. There is no special restriction on the type and content of these other ingredients, as long as the required performance of the single-component epoxy adhesive composition of the invention is not affected.

The single-component epoxy adhesive composition according to the invention may or may not comprise a solvent. In a preferred embodiment, the single-component epoxy adhesive composition of the present invention contains no solvent, especially organic solvent.

According to another aspect of the invention, there is provided a method for preparing the single-component epoxy adhesive composition, the method comprising uniformly mixing each component as described above of the single-component epoxy adhesive composition. There is no special restriction on the specific mixing method or the mixing sequence of each component, and a person skilled in the art can reasonably determine according to specific technical requirements and process conditions.

The single-component epoxy adhesive composition according to the above method has high light transmittance after curing (light transmittance ≥95%), long time available for construction (more than 24 h), good adhesion (shear strength ≥5 MPa), and in particular good weather resistance (the epoxy adhesive is not yellowed and the light transmittance is ≥90% after irradiation with 405 nm-wavelength UV LED at an illuminance of 5 W/cm² for 200 h), and is suitable for electronic industrial assembly, and especially for the assembly and sealing of electronic display devices.

The present invention will be described in more detail below with reference to examples. It should be pointed out that these descriptions and examples are for the purpose of facilitating the understanding of the present invention, rather than limiting the present invention. The scope of protection of the present invention is subject to the appended claims.

### EXAMPLES

The present invention is further described in detail below with reference to examples and comparative examples. It should be understood that the present invention is not limited to the following examples.

In the following examples and comparative examples, unless otherwise specified, “portion” refers to “portion by weight,” “%” refers to weight percent “wt %”, and “g” refers to the weight unit “gram.” In the present invention, unless otherwise indicated, the used reagents are all commercially available products and are used directly without being further purified.

TABLE 1
List of raw materials

| Component | Product Name | Description | Supplier |
|---|---|---|---|
| Epoxy resin | YX8000D | Hydrogenated bisphenol A diglycidyl ether | Mitsubishi Chemical |
| | | | Corporation |
| | Heloxy 107 | 1,4-Cyclohexanedimethanol diglycidyl ether | Hansen Chemical |
| | | | Corporation |
| | GE-30 | Trimethylolpropane triglycidyl ether | CVC Thermosetting |
| | | | Special Materials |
| | | | Corporation |
| | DER331 | Bisphenol A diglycidyl ether | Lanke Chemical Olin |
| | | | Corporation |
| Polymercaptan | TMPMP | Trimethylolpropane tri(3-mercaptopropionate) | Bruno Bock Corporation |
| | PETMP | Pentaerythritol tetra-3-mercaptopropionate | Bruno Bock Corporation |
| | TEMPIC | Tri[2-(3- | Bruno Bock Corporation |
| | | mercaptopropionyloxy)ethyl]isocyanurate | |
| Initiator | FXR-1081 | Latent amine initiator | T&K TOKA Co., Ltd. |
| | | | of Japan |
| | 2E4MZ | 2-Ethyl-4-methylimidazole | Sikoku Chemical |
| | | | Industry Co., Ltd. |
| | C17Z | 2-Heptadecyl imidazole | Sikoku Chemical |
| | | | Industry Co., Ltd. |
| System stabilizer | L-07N | Dineopentyl glycol metaborate | Sikoku Chemical |
| | | | Industry Co., Ltd. |
| Silane coupling | KH560 | Silane coupling agent | Sinopharm Chemical |
| agent | | | Reagent Co., Ltd. |

### Test Methods

According to the specific method described below, each single-component epoxy adhesive composition prepared in the following examples and comparative examples was tested for viscosity, time available for construction, adhesion, light transmittance, and ultraviolet resistance.

### Viscosity

The viscosity (unit: centipoise (cPs)) of each single-component epoxy adhesive composition prepared in the following examples and comparative examples was measured by using the HBDV-II+Pro viscometer manufactured by Brookfield Company. Where, the test temperature was 23° C., and a 4 #rotor was employed, at a speed of 100 rotations per minute (rpm).

The viscosity of the prepared epoxy adhesive needed to be less than 10000 cPs to meet the requirements of conventional adhesion construction of epoxy adhesive products.

### Time Available for Construction

Each single-component epoxy adhesive composition prepared in the following examples and comparative examples was placed at room temperature (23° C.) respectively, and its viscosity change was monitored by the viscosity measurement method described above. The time that the epoxy adhesive was held at room temperature (23° C.) until its viscosity increased by 50% was taken as the time available for construction (unit: day).

The time available for construction of the prepared epoxy adhesive should reach at least 1 day (24 h) or more to meet the use requirements for conventional adhesion of epoxy adhesive products.

### Lap Shear Strength

Each single-component epoxy adhesive composition prepared in the following examples and comparative examples was respectively coated on a 1.27 centimeter (cm)×2.54 cm aluminum alloy plate (Al 6063: Jiangsu Kunshan Great Wall Printing Factory) with a coating thickness of 100 micrometers (μm). Then, the coated aluminum alloy plate was dried at 110° C. for 0.5 hours (h), to completely cure the single-component epoxy adhesive composition on the Al 6063 plate. Then, according to a dynamic shear test standard, i.e., the ASTM D1002-72 standard, the lap shear strength (unit: megaPascals (MPa)) of the sample was tested at room temperature (22-24° C.) at a tensile speed of 2.54 millimeters per minutes (mm/min) by an Instron 5969 apparatus manufactured by Instron Company, US.

The lap shear strength of the prepared epoxy adhesive needed to reach at least 5 MPa or more, to meet the conventional requirements for adhesion performance of epoxy adhesive products.

### Light Transmittance

Each single-component epoxy adhesive composition prepared in the following examples and comparative examples was respectively coated on a release paper with a coating thickness of 10 μm, and dried at 110° C. for 0.5 h. After it was completely cured to form a film, the release paper was removed, and the adhesive film was cut to a size of 3 cm×5 cm. Then, a transmission percentage of light with a wavelength of 450-455 nanometers (nm) was measured by a UV-1900i ultraviolet visible spectrophotometer manufactured by Shimadzu, Japan, and was taken as the light transmittance before aging (%).

The light transmittance before aging of the cured epoxy adhesive should be at least 95% to meet the conventional use requirements for light transmittance of electronic display devices.

### Aging Resistance (Ultraviolet Resistant)

Each single-component epoxy adhesive composition prepared in the following examples and comparative examples was respectively coated on a release paper with a coating thickness of 10 μm, and dried at 110° C. for 0.5 h. After it was completely cured to form a film, the release paper was removed, and the adhesive film was cut to a size of 3 cm×5 cm. Then, the sample was irradiated with a high intensity UV LED lamp with a wavelength of 405 nm (Futansi Company, Model UVSF81T) at an illuminance of 5 W/cm² for 200 h. Then, a transmission percentage of light with a wavelength of 450-455 nm was measured by a Shimadzu UV-1900i ultraviolet visible spectrophotometer and was taken as the light transmittance after aging (%).

The light transmittance after aging of the cured epoxy adhesive which had been subjected to the above aging treatment should be at least 90%, to meet the conventional use requirements for light transmittance of electronic display devices.

### Example 1 (E1)

56.5 g of hydrogenated bisphenol A diglycidyl ether YX8000D, 41.0 g of trimethylolpropane tri (3-mercaptopropionate) TMPMP, 2.0 g of a latent amine initiator FXR-1081, and 0.5 g of dineopentyl glycol metaborate L-07N were uniformly mixed, to obtain a single-component epoxy adhesive composition 1.

The single-component epoxy adhesive composition 1 was tested for viscosity, time available for construction, lap shear strength, light transmittance, and aging resistance (ultraviolet resistance) respectively according to the test methods specifically described above, and the results are shown in Table 2 below.

### Examples 2-14 (E2-E14) and Comparative Examples 1-5 (C1-C5)

Examples 2-14 (E2-E14) and Comparative Examples 1-5 (C1-C5) were carried out, in which single-component epoxy adhesive compositions E2-E14 and comparative single-component epoxy adhesive compositions C1-C5 were prepared in a similar manner to Example 1, except only that, the specific type and content of each component were changed as shown in Table 2 below.

The single-component epoxy adhesive compositions E2-E14 and comparative single-component epoxy adhesive compositions C1-C5 were tested for viscosity, time available for construction, lap shear strength, light transmittance, and aging resistance (ultraviolet resistance) respectively according to the test method specifically described above, and the results are shown in Table 2 below.

TABLE 2
Composition ratio and performance test results of single-component epoxy adhesive
compositions E1-E14 and comparative single-component epoxy adhesive compositions
C1-C5 prepared in Examples 1-14 (E1-E14) and Comparative examples 1-5 (C1-C5)

| | E1 | E2 | E3 | E4 | E5 | E6 | E7 | E8 | E9 | E10 |
|---|---|---|---|---|---|---|---|---|---|---|
| YX8000D | 56.5 | 63.9 | 63.8 | 62.1 | 52.1 | 59.0 | 43.4 | | | 66.0 |
| Heloxy 107 | | | | | | | | 47.3 | 48.5 | |
| GE-30 | | | | | | | | | | |
| DER331 | | | | | | | | | | |
| TMPMP | 41.0 | | | | | 40.1 | | | | 33.7 |
| PETMP | | 35.8 | 35.7 | 34.8 | 34.0 | | | | | |
| TEMPIC | | | | | | | 56.4 | 52.5 | 49.7 | |
| FXR-1081 | 2.0 | | | 2.5 | 11.1 | | | | 1.0 | |
| 2E4MZ | | 0.3 | 0.3 | | | 0.3 | 0.2 | 0.2 | | 0.3 |
| C17Z | | | | | | | | | | |
| L-07N | 0.5 | | 0.2 | 0.6 | 2.8 | | | | 0.3 | |
| KH560 | | | | | | 0.6 | | | 0.5 | |
| Total amount (%) | 100 | 100 | 100 | 100 | 100 | 100 | 100 | 100 | 100 | 100 |

Performance test results

| | | | | | | | | | | |
|---|---|---|---|---|---|---|---|---|---|---|
| Viscosity (cPs) | 560 | 1040 | 1056 | 1440 | 1776 | 496 | 2608 | 704 | 720 | 848 |
| Time available for | 4 | 2 | 4 | 4 | 3 | 2 | 1 | 3 | 3 | 1 |
| construction (days) | | | | | | | | | | |
| Overlap shear | 7.0 | 14.6 | 14.5 | 13.5 | 16.0 | 8.3 | 8.6 | 5.1 | 6.3 | 5.5 |
| strength (MPa) | | | | | | | | | | |
| Light transmittance | 99.8 | 99.9 | 99.9 | 99.6 | 95.2 | 99.0 | 97.0 | 99.5 | 99.5 | 99.5 |
| before aging (%) | | | | | | | | | | |
| Light transmittance | 98.0 | 99.0 | 98.9 | 98.0 | 90.3 | 98.2 | 93.2 | 99.1 | 99.0 | 99.0 |
| after aging (%) | | | | | | | | | | |

| | E11 | E12 | E13 | E14 | C1 | C2 | C3 | C4 | C5 |
|---|---|---|---|---|---|---|---|---|---|
| YX8000D | 60.4 | 49.4 | | | | | 68.3 | 38.1 | 50.0 |
| Heloxy 107 | | 5.0 | | | | | | | |
| GE-30 | | 6.0 | 43.4 | 44.3 | | | | | |
| DER331 | | | | | 56.5 | 63.9 | | | |
| TMPMP | | 5.2 | | | 41.0 | | 31.4 | | |
| PETMP | 33.2 | 28.0 | | | | 35.8 | | | 34.4 |
| TEMPIC | 6.0 | 6.0 | 56.4 | 55.1 | | | | 61.7 | |
| FXR-1081 | | | | | 2.0 | | | | 12.8 |
| 2E4MZ | | | 0.2 | 0.2 | | 0.3 | 0.3 | 0.2 | |
| C17Z | 0.4 | 0.4 | | | | | | | |
| L-07N | | | | | 0.5 | | | | 2.8 |
| KH560 | | | | 0.4 | | | | | |
| Total amount (%) | 100 | 100 | 100 | 100 | 100 | 100 | 100 | 100 | 100 |
| | Performance test results | | | | | | | | |
| Viscosity (cPs) | 1072 | 832 | 5200 | 4800 | 784 | 2640 | 880 | 2960 | 1856 |
| Time available for | 6 | 6 | 1 | 1 | 4 | 2 | 2 | 3 | 3 |
| construction (days) | | | | | | | | | |
| Overlap shear | 15.0 | 14.0 | 5.3 | 6.2 | 12.8 | 12.3 | 4.2 | 4.3 | 16.0 |
| strength (MPa) | | | | | | | | | |
| Light transmittance | 99.1 | 99.6 | 99.7 | 99.8 | 99.0 | 99.0 | 98.0 | 97.0 | 92.0 |
| before aging (%) | | | | | | | | | |
| Light transmittance | 98.3 | 98.8 | 99.2 | 98.7 | 29.0 | 26.0 | 97.0 | 95.0 | 87.0 |
| after aging (%) | | | | | | | | | |

It can be seen from the results of Examples 1-14 (E1-E14) in Table 2 above that, through the use of a combination of an epoxy resin without a benzene ring structure, polymercaptan and an initiator in specific contents, the prepared single-component epoxy adhesive composition after curing had good light transmittance before aging (light transmittance ≥95%), long time available for construction (more than 24 h), good adhesion (shear strength ≥5 MPa), and in particular good weather resistance (the epoxy adhesive was not yellowed and the light transmittance was ≥90% after irradiation with a 405 nm-wavelength UV LED at an illuminance of 5 W/cm² for 200 h), and is suitable for electronic industrial assembly, and especially for the assembly and sealing of electronic display devices.

By comparing the results of Example 1 (E1) with Comparative example 1 (C1), it can be seen that when hydrogenated bisphenol A diglycidyl ether YX8000D without a benzene ring structure in the molecule was replaced with bisphenol A diglycidyl ether DER331 with a benzene ring structure despite its very similar molecular structure, the aging resistance of the obtained epoxy adhesive was greatly degraded, and the light transmittance of the cured epoxy adhesive after the aging test was only 29.0%, which is far from meeting the performance requirements for transparent structural adhesive products in the technical field of assembly and sealing of electronic display devices.

By comparing the results of Example 2 (E2) with Comparative example 2 (C2), it can be seen that when hydrogenated bisphenol A diglycidyl ether YX8000D without a benzene ring structure in the molecule was replaced with bisphenol A diglycidyl ether DER331 with a benzene ring structure despite its very similar molecular structure, the aging resistance of the obtained epoxy adhesive was greatly degraded, and the light transmittance of the cured epoxy adhesive after the aging test was only 26.0%, which is far from meeting the performance requirements for transparent structural adhesive products in the assembly and sealing processes of electronic display devices.

It can be seen from the results of Comparative example 3 (C3) that, when the content of the epoxy resin without a benzene ring structure in the single-component epoxy adhesive composition is too high (e.g., 68.3 wt %) and the content of polymercaptan is too low (e.g., 31.4 wt %), the lap shear strength of the obtained epoxy adhesive is too low (e.g., 4.2 MPa), which cannot meet the basic requirements for the adhesion performance of the epoxy adhesive in the electronic industry assembly.

It can be seen from the results of Comparative example 4 (C4) that, when the content of the epoxy resin without a benzene ring structure in the single-component epoxy adhesive composition is too low (e.g., 38.1 wt %) and the content of polymercaptan is high (e.g., 61.7 wt %), the lap shear strength of the obtained epoxy adhesive is too low (e.g., 4.3 MPa), which cannot meet the basic requirements for the adhesion performance of the epoxy adhesive in the electronic industry assembly.

It can be seen from the results of Comparative example 5 (C5) that, when the initiator content in the single-component epoxy adhesive composition is too high (e.g., 12.8 wt %), the light transmittance of the obtained epoxy adhesive after curing is too low (e.g., 92.0%), and the light transmittance after the aging test is further greatly degraded (e.g., 87.0%), which cannot meet the light transmittance requirements for structural adhesive products in the assembly and sealing process of electronic display devices.

Although specific embodiments have been shown and described in the present invention, a person skilled in the art would understand that various alternative and/or equivalent embodiments may be used to substitute the specific embodiments shown and described without departing from the scope of the present invention. The present application is intended to encompass any adaptations or variations of the specific embodiments discussed in the present invention. Accordingly, the present invention is subject only to the claims and equivalents thereof.

A person skilled in the art should appreciate that various modifications and changes could be made without departing from the scope of the present invention. Such modifications and changes are intended to fall within the scope of the present invention as defined by the appended claims.

1. A single-component epoxy adhesive composition comprising, based on the total weight thereof as 100 weight percent:
42-67 weight percent of an epoxy resin without a benzene ring structure;
32-57 weight percent of a polymercaptan selected from one or more of trimethylolpropane tri (3-mercaptopropionate), pentaerythritol tetra-3-mercaptopropionate, and tri[2-(3-mercaptopropionyloxy)ethyl] isocyanurate; and
0.1-12 weight percent of an initiator selected from one or more of latent amine initiators and imidazole initiators.

2. The single-component epoxy adhesive composition according to claim 1, wherein the epoxy resin without a benzene ring structure is an epoxy resin with a cyclohexane structure and without a benzene ring structure.

3. The single-component epoxy adhesive composition according to claim 1, wherein the epoxy resin without a benzene ring structure is a diglycidyl ether epoxy resin with a cyclohexane structure and without a benzene ring structure.

4. The single-component epoxy adhesive composition according to claim 1, wherein the epoxy resin without a benzene ring structure has an epoxy functionality of 2 or 3.

5. The single-component epoxy adhesive composition according to claim 1, wherein the epoxy resin without a benzene ring structure has a number average molecular weight ranging from 200 to 500 grams per mole.

6. The single-component epoxy adhesive composition according to claim 1, wherein the epoxy resin without a benzene ring structure has a molecular weight ranging from 200 to 500 grams per mole.

7. The single-component epoxy adhesive composition according to claim 1, wherein the epoxy resin without a benzene ring structure is selected from one or more of hydrogenated bisphenol A diglycidyl ether, 1,4-cyclohexanedimethanol diglycidyl ether, and/or trimethylolpropane triglycidyl ether.

8. The single-component epoxy adhesive composition according to claim 1, wherein based on the total weight of the single-component epoxy adhesive composition as 100 weight percent, the single-component epoxy adhesive composition comprises 45-65 weight percent of the epoxy resin without a benzene ring structure.

9. The single-component epoxy adhesive composition according to claim 1, wherein based on the total weight of the single-component epoxy adhesive composition as 100 weight, the single-component epoxy adhesive composition comprises 50-65 weight percent of the epoxy resin without a benzene ring structure.

10. The single-component epoxy adhesive composition according to claim 1, wherein the polymercaptan is pentaerythritol tetra-3-mercaptopropionate.

11. The single-component epoxy adhesive composition according to claim 1, wherein the initiator is selected from one or more imidazole initiators.

12. The single-component epoxy adhesive composition according to claim 1, wherein based on the total weight of the single-component epoxy adhesive composition as 100 weight percent, the single-component epoxy adhesive composition comprises a system stabilizer in an amount of less than or equal to 2.8 weight percent.

13. The single-component epoxy adhesive composition according to claim 12, wherein the system stabilizer is selected from one or more of dineopentyl glycol metaborate and 1-benzyl-5-phenylbarbituric acid.

14. The single-component epoxy adhesive composition according to claim 1, wherein based on the total weight of the single-component epoxy adhesive composition as 100 weight percent, the single-component epoxy adhesive composition comprises a silane coupling agent in an amount of less than or equal to 0.6 weight percent.

15. A method for preparing a single-component epoxy adhesive composition according to claim 1, the method comprising uniformly mixing the epoxy resin without a benzene ring structure, the polymercaptan, and the initiator.

16. The single-component epoxy adhesive composition according to claim 9, wherein the epoxy resin without a benzene ring structure is hydrogenated bisphenol A diglycidyl ether.

17. The single-component epoxy adhesive composition according to claim 1, which contains no organic solvent.

18. The single-component epoxy adhesive composition according to claim 1, wherein the epoxy resin without a benzene ring structure is hydrogenated bisphenol A diglycidyl ether.

19. The single-component epoxy adhesive composition according to claim 1, wherein the initiator is selected from one or more latent amine initiators.

20. The single-component epoxy adhesive composition according to claim 1, wherein based on the total weight of the single-component epoxy adhesive composition as 100 weight percent, the single-component epoxy adhesive composition comprises dineopentyl glycol metaborate in an amount of less than or equal to 2.8 weight percent.
